(19) United States
(12) Patent Application Publication
(10) Pub. No.: US 2017/0191455 A1
(43) Pub. Date: Jul. 6, 2017

(54) Fuel Injection Valve and Method for Producing Same

(71) Applicant: CONTINENTAL AUTOMOTIVE GMBH, Hannover (DE)

(72) Inventors: Ileana Romeo, Grossetto (IT); Tommaso Rosi, Pisa (IT)

(73) Assignee: CONTINENTAL AUTOMOTIVE GMBH, Hannover (DE)

(21) Appl. No.: 15/468,499

(22) Filed: Mar. 24, 2017

Related U.S. Application Data
(63) Continuation of application No. PCT/EP2015/071165, filed on Sep. 16, 2015.

(30) Foreign Application Priority Data
Oct. 2, 2014 (DE) 10 2014 220 100.4

(51) Int. Cl. F02M 51/06; F02M 61/18; F02M 61/12

(52) U.S. Cl. CPC F02M 51/0685; F02M 61/12; F02M 61/188; F02M 2200/02; F02M 2200/9038

(57) ABSTRACT

An injection valve, including a valve body having a longitudinal axis; a valve needle axially movable in the valve body between closed and open positions; and an actuator having a movable armature coupled to the valve needle in order to move same, and a pole element fixed in the body, wherein an armature surface contacts a pole surface when the valve needle reaches the open position. The valve needle has a needle sleeve arranged in a through opening of the pole element such that a lateral surface of the needle sleeve is in sliding contact with the surface of the through opening for guiding valve needle movement. At least one of the surface of the through opening and the lateral surface of the needle sleeve is formed by a chromium nitride layer. The pole surface includes plural annular surfaces, only one of which contacts the armature surface.

### CROSS REFERENCE TO RELATED APPLICATIONS

This application claims the benefit of PCT Application PCT/EP2015/071165, filed Sep. 16, 2015, which claims priority to German Application DE 10 2014 220 100.4, filed Oct. 2, 2014. The disclosures of the above applications are incorporated herein by reference.

### TECHNICAL FIELD

The invention relates to a fuel injection valve and to a method for producing the fuel injection valve.

### BACKGROUND

Fuel injection valves are used to atomize fuel in a combustion chamber of an internal combustion engine. In particular, where it is a matter of “direct injection” of the fuel into the combustion chamber in the case of an internal combustion engine designed as a spark-ignition engine, the fuel must be atomized very finely, with the aid of the nozzle head inter alia. Combustion in a spark-ignition engine is based on the principle of homogeneous combustion, which requires a fine mixture of air present in the combustion chamber and the injected fuel to produce combustion which is as complete as possible.

Since the progress of combustion in the combustion engine is dependent on the opening and closing of an injection nozzle of the fuel injection valve, in addition to other injection parameters, e.g., the injected quantity or injection temperature, a precise start of injection, i.e., opening of the valve opening, and a precise end of injection, i.e., closing of the valve opening, are indispensable to compliance with, for example, power and fuel consumption as well as emissions requirements of the combustion engine.

Wear, which is caused by repeated striking of the armature on the pole element as part of operation, can lead to changes and unwanted tolerances in the opening and closing times over the service life.

U.S. Pat. No. 5,732,888 A discloses a fuel injection valve, the pole element and armature of which have a coating on their mutually facing surfaces to minimize wear. In this case, the mutually facing surfaces of the pole element and of the armature are not of plane-parallel configuration but are wedge-shaped.

### SUMMARY

It is the object of the present invention to provide a fuel injection valve by means of which fuel metering that is particularly accurate and/or particularly constant over the service life of the valve can be achieved.

According to the invention, this object is achieved by a fuel injection valve and a method for producing the fuel injection valve having the features of the independent claims. Advantageous embodiments and developments are specified in the dependent claims.

According to one aspect of the present disclosure, a fuel injection valve is specified. This has a valve body, through which fuel can flow and which has a longitudinal axis. The fuel injection valve furthermore has a valve needle, which is accommodated in an axially movable manner in the valve body. In a closed position, the valve needle prevents fuel flow through a spray hole of the fuel injection valve and, in an open position, allows fuel flow from the valve body through the spray hole for the atomization of the fuel.

Moreover, the fuel injection valve has an electromagnetic actuator. The actuator has an armature, a solenoid and a pole element.

The armature is accommodated in an axially movable manner in the valve body. It is expedient if the armature is supported so as to be axially movable in relation to the valve body. The armature is mechanically coupled to the valve needle in order to move the valve needle axially from the closed position to the open position. Either the armature is formed integrally with the valve needle or connected in a fixed manner to the valve needle. As an alternative, the armature is axially movable in relation to the valve needle. In this case, the valve needle preferably has a stop element, which limits the axial play of the armature relative to the valve needle and with which the armature enters into a positive connection in order to move the valve needle away from the closed position.

The solenoid is designed to move the armature, that is to say, in particular, to move the armature relative to the valve body. In particular, the solenoid may be supplied with an operating current in order to produce a magnetic field, by means of which the armature is pulled in a direction toward the pole element.

The pole element is fixed in relation to the valve body. For example, the pole element is secured in the valve body or of integral design with the valve body. It is arranged opposite the armature in such a way that an armature surface of the armature strikes a pole surface of the pole element when the valve needle reaches the open position.

In one embodiment, the armature surface is formed by a chromium nitride layer of the armature. In this embodiment, the pole surface may alternatively or additionally be formed by a chromium nitride layer of the pole element. In other words, the armature has a chromium nitride layer and at least part of the surface of the chromium nitride layer forms the armature surface, and/or the pole element has a chromium nitride layer and at least part of the surface of the chromium nitride layer forms the pole surface.

In the present context, the chromium nitride layer(s) is a layer which contains or consists of chromium and nitrogen—in particular CrN, CR₂N or CrN where 0.05≦x≦1. One expedient possibility is for the chromium nitride layer to be applied to a main body of the respective component, that is to say, in particular, of the armature or of the pole element. The main body is a stainless steel body, for example.

In an advantageous embodiment, the valve needle has a needle sleeve, which is arranged in an axial through opening, with the result that a lateral surface of the needle sleeve is in sliding contact with a section of the surface of the through opening which encircles the longitudinal axis in order to guide the valve needle axially. It is preferably the pole element which has the through opening.

The section of the surface of the through opening with which the lateral surface of the needle sleeve is in sliding contact is preferably formed by a chromium nitride layer, in particular by a surface of the chromium nitride layer of the pole element. In a development, the chromium nitride layer is made to extend continuously from the pole surface of the pole element to the section. In another development, the chromium nitride layer of the pole element has two separate parts, one in the region of the section of the through opening and one in the region of the pole surface.

The needle sleeve forms the stop element for the armature, for example. The needle sleeve may be secured on a stem of the valve needle or may be formed integrally with the stem. The needle sleeve is preferably positioned on an axial end of the valve needle remote from the spray hole. In an advantageous embodiment which is provided—in particular as an alternative or in addition to the through opening—with a chromium nitride layer which, in particular, has the lateral surface that is preferably in sliding contact with the chromium nitride layer in the through opening of the pole element.

In one embodiment, the armature is axially movable in relation to the valve needle, and the armature surface may be coupled positively to a stop surface of the needle sleeve in order to move the valve needle axially. In this case, the armature surface and/or the stop surface is/are formed by a chromium nitride layer of the armature and/or of the needle sleeve, respectively. In particular, the needle sleeve has an integral and continuous chromium nitride layer, which forms the lateral surface and the stop surface of the needle sleeve.

A coating of this kind has a particularly good wear resistance. In particular, wear resistance is improved over an electro-deposited chromium layer. In this way, particularly good durability or service life of the coating can be achieved. In this way, it is possible to ensure particularly little drift of the injected quantity over the service life of the valve, assuming identical control of the valve.

By means of the chromium nitride layer(s), it is also possible to achieve a particularly low friction coefficient. In particular, this is reduced as compared with an electro-deposited chromium coating. Thus, the fuel injection valve may be controlled in a particularly precise way.

Moreover, a “magnetic gap” may be achieved between the respective components by means of the chromium nitride layer(s). In particular, the magnetizable main bodies of the armature and the pole element are not in direct mechanical contact. This enables the armature to be released particularly quickly from the pole element to close the valve. The risk that the armature will remain stuck on the pole piece owing to remanent magnetization after the operating current through the solenoid is switched off is particularly low. This makes the closing process of the fuel injection valve particularly quick and precise.

According to another aspect of the present disclosure, the method for producing the fuel injection valve is specified. The method comprises a physical gas phase deposition process (PVD, or physical vapor deposition) for the production of the chromium nitride layer or chromium nitride layers.

By means of the method, a particularly low coating thickness scatter may be achieved. In particular, the layer thicknesses of different injection valves differ particularly little from one another and/or there is particularly little variation in the layer thicknesses at different points of each of the chromium nitride layers. In the case of electrodeposited layers, for example, the layer thickness is, in contrast, high and increased in a manner which is difficult to predict at corners of the coated components, for example. In one embodiment of the fuel injection valve, the pole surface has a first annular surface, which is formed orthogonally to the longitudinal axis. The first annular surface is aligned parallel to the armature surface and lies opposite the latter. The armature surface strikes the first annular surface when the valve needle reaches the open position. The pole surface and the armature surface are preferably shaped in such a way that a gap is formed between the armature surface and the pole surface radially inward from the first annular surface. The axial extent of said gap increases radially toward the valve needle, in particular continuously. In other words, the armature surface and the pole surface extend axially toward one another in a radial direction from the longitudinal axis to the first annular surface until they touch at an inner edge of the first annular surface. In a development, the gap is formed by means of a second annular surface of the pole surface, which annular surface adjoins the first annular surface in a radially inward direction and slopes and/or curves away from the first annular surface in a radial direction toward the longitudinal axis, away from the armature surface. In this case, the armature surface is preferably of flat design, in particular extending in a plane perpendicular to the longitudinal axis. In a development, an angle which has a value of between 1° and 4°, including the limits, is formed between the armature surface and the pole surface in the region of the gap. For example, the angle has a value of 2°.

With stop surfaces shaped in this way, particularly low magnetic and/or hydraulic adhesion of the armature on the pole element can be achieved, thus enabling particularly short and reproducible closing times of the valve to be achieved. In the case of a chromium nitride coating, the risk that the stop surface will become enlarged in an unwanted manner by wear over the service life is advantageously particularly low, despite the relatively small stop surface, which is predetermined by the extent of the first annular surface. In this way, the closing time of the valve may remain virtually constant over the service life, for example. In the case of a chromium nitride coating, it is, in particular, already the case that the main bodies of the armature and the pole element have an appropriate shape, which the chromium nitride layer(s) follows. It is particularly advantageous to produce the shape mechanically by means of a ground countersink. Thus, very precise dimensions can be achieved. With the aid of the very precisely ground tools, particularly close manufacturing tolerances can be maintained, with the result that there is very little scatter in the pull-in and, in particular, release time of the armature to and from the pole element between different injection valves of identical construction.

It is advantageous for the chromium nitride layers to be applied to the main body of the armature and/or of the pole element with a layer thickness which is constant over the armature surface and/or over the pole surface. Particularly in the case of application by means of a physical gas phase deposition process, the shape of the main body is maintained with particular precision, even when the body is coated.

In one embodiment of the fuel injection valve, the pole surface has a third annular surface, which, while adjoining the first annular surface, extends radially outward in a direction toward a circumferential surface, remote from the longitudinal axis, of the pole element. The third annular surface slopes and/or curves in a radial direction away from the longitudinal axis and away from the armature surface, which is, in particular, flat. In this way, the magnetic and/or hydraulic adhesion of the armature to the pole element may be further reduced.

In another embodiment, the surface of the armature has a chamfer, which is formed between the armature surface and a circumferential surface, remote from the longitudinal axis, of the armature. Thus, the risk that the armature will jam in the valve body during its axial movement is particularly low. Further advantages and advantageous embodiments and developments of the fuel injection valve and of the method will become apparent from the following illustrative embodiment explained in conjunction with the figures.

### BRIEF DESCRIPTION OF THE DRAWINGS

The features and combinations of features mentioned above in the description and the features and combinations of features which are mentioned below in the description of the figures and/or which are shown only in the figures can be used not only in the respectively indicated combination but also in other combinations and in isolation without exceeding the scope of the invention. Identical reference signs are allocated to elements which are the same or functionally identical. For reasons of clarity, it is possible that the elements will not be provided with their reference signs in all the figures, but they will not thereby lose their association.

FIG. 1 shows a fuel injection valve according to an embodiment of the invention in a longitudinal section,

FIG. 2 shows a detail of the fuel injection valve shown in FIG. 1, and

FIG. 3 shows a basic diagram of an armature and a pole element of the fuel injection valve according to an embodiment of the invention in a longitudinally sectioned detail.

### DETAILED DESCRIPTION

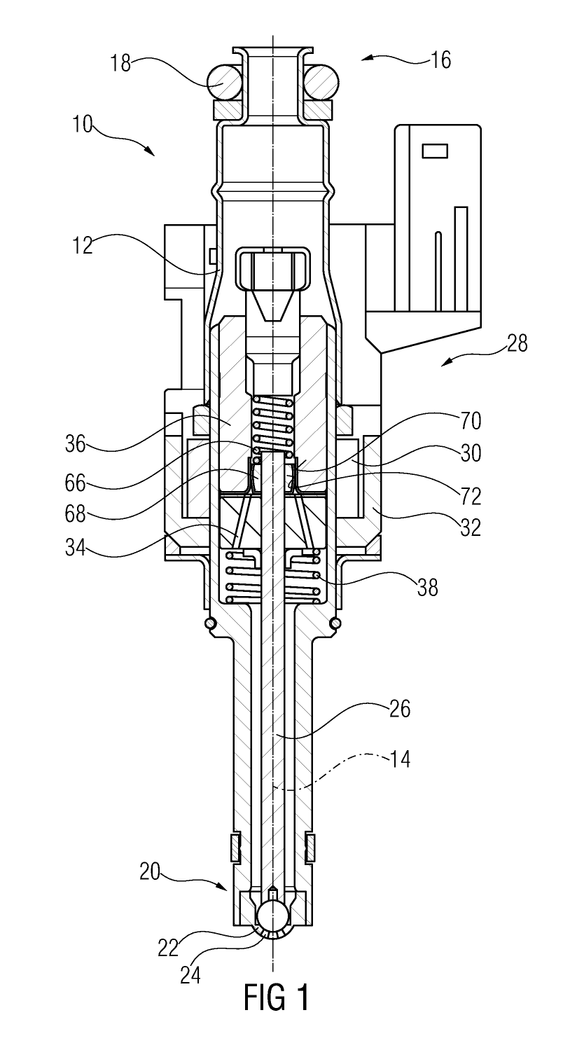

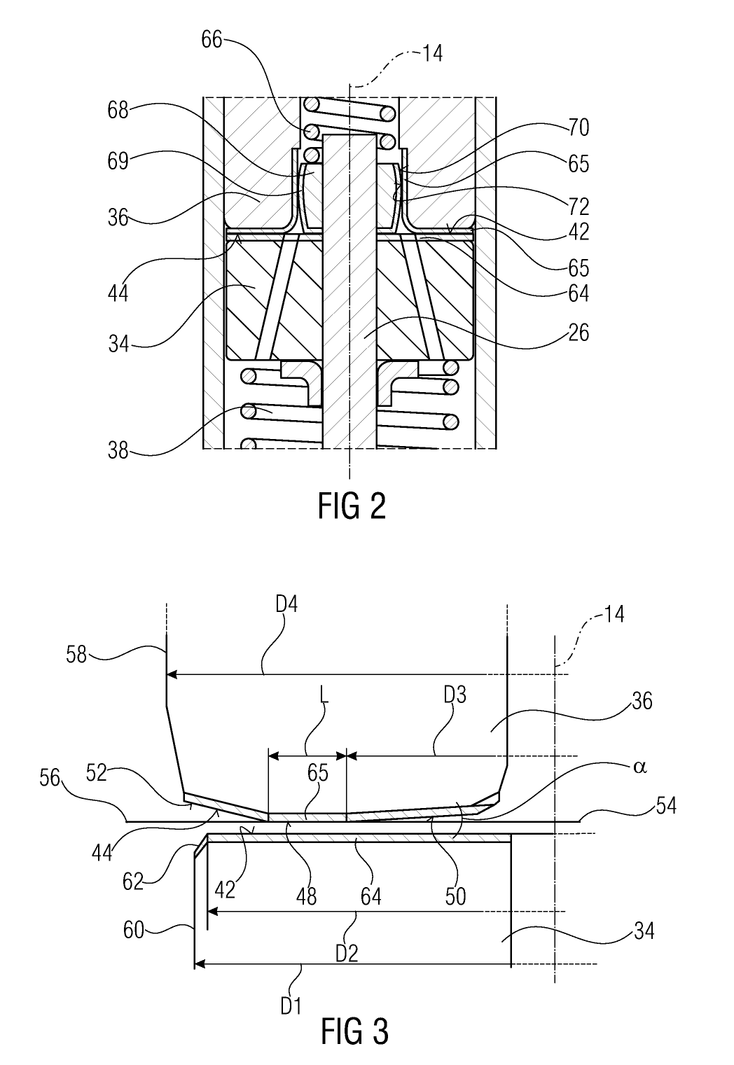

FIG. 1 shows an illustrative embodiment of a fuel injection valve 10 according to an embodiment of the invention for an internal combustion engine (not shown specifically). The fuel injection valve 10 has a valve body 12 with a longitudinal axis 14, wherein the fuel injection valve 10 is mounted at a first end 16 of the valve body 12 on a fuel rail (not shown specifically) for supplying a fluid—in particular a fuel for the internal combustion engine.

To seal off the connection between the fuel injection valve 10 and the fuel rail, a sealing element 18 is arranged in the region of the first end 16, completely surrounding the valve body 12 over the circumference thereof. In particular, the sealing element 18 is an O-ring seal.

A nozzle head 22 for atomization of the fluid is arranged or formed at a second end 20 of the valve body 12, opposite the first end 16.

The nozzle head 22 is positioned at the second end 20 of the fuel injection valve 10, which is arranged in a combustion chamber (not shown specifically) of an internal combustion engine (not shown specifically). This means that fuel which is fed to the internal combustion engine with the aid of the fuel injection valve is injected directly into the combustion chamber.

The nozzle head 22 has spray holes 24, through which the fluid is injected from the valve body 12 into the combustion chamber. Fuel flow through the spray holes 24 may be enabled or prevented by means of a valve needle 26 of the fuel injection valve 10. For this purpose, the valve needle 26 may be moved axially along the longitudinal axis 14. In other words, the valve needle 26 may perform a reciprocating motion in the valve body 12.

This reciprocating motion is initiated by means of an actuator 28. This actuator 28 has a solenoid 30, which is accommodated in a solenoid housing 32 outside the hollow valve body 12. Moreover, the actuator 28 has an armature 34 which is movably accommodated in the valve body 12 and which is mechanically coupled to the valve needle 26 in order to move the valve needle 26 away from a closed position. In the present case, the mechanical coupling is accomplished by means of a positive connection between the armature 34 and a needle sleeve 68, which serves as a stop element that limits the axial play of the armature 34 relative to the valve needle 26 in a direction toward the pole piece 36.

The armature 34 is axially spring-loaded in a direction toward the needle sleeve 68 by means of an armature return spring 38. The needle sleeve 68 is connected in a fixed manner to a stem of the valve needle 26 and is arranged on an end of the valve needle 26 remote from the nozzle head 22. An immovable pole element 36 is positioned adjacent to the armature 34 in the valve body 12. If the solenoid 30 is supplied with current, a magnetic field is established between the armature 34 and the pole element 36, by means of which the armature 34 is pulled in an axial direction toward the pole element 36.

As soon as the armature 34 strikes the pole element 36, an open position of the valve needle 26 is reached. The open position corresponds, in particular, to a maximum needle stroke—if appropriate apart from any brief overshoot by the valve needle. In the open position, fuel is discharged from the fuel injection valve 10 through the spray holes 24 during operation.

If the energization of the solenoid 30 is ended, the magnetic field collapses after a short time, and a closing spring 66 pushes the valve needle 26 back in an axial direction into the closed position, in contact with a valve seat 40 formed in the nozzle head 22, with the result that fluid may no longer flow into the combustion chamber via the spray holes 24. The needle sleeve 68 forms a spring seat for the closing spring 66.

The armature 34 has an armature surface 42, which is arranged opposite a pole surface 44 of the pole element 36 and a stop surface 71 of the needle sleeve 68. A gap 46 is formed between the armature surface 42 and the pole surface 44, with the result that the mutually striking surfaces of the armature and of the pole element 36 are kept small. In this way, particularly low, unwanted adhesion of the armature 34 to the pole element 36 due to hydraulic and/or magnetic effects may be achieved. The armature return spring 38 pushes the armature surface 42 in a direction toward the stop surface 71, with the result that the armature 34 takes the valve needle 26 along through the positive coupling between the armature surface 42 and the stop surface 71 when it moves in a direction toward the pole surface 44 in order to open the valve. At the end of the closing movement of the valve needle 26, the armature surface 42 comes away from the stop surface 71 when the valve needle 26 comes into contact with the valve seat 40, and the armature 34 continues to move, counter to the spring force of the armature return spring 38, before finally being brought back into contact with the stop surface 71.

To form the gap 46, the pole surface 44 is divided into three annular surfaces 48, 50, 52, which follow one another in a radial direction. By means of the three annular surfaces 48, 50, 52, the pole surface 44 is designed as a double-wedge surface of the pole element 36. A detail of the armature 34 and of the pole element 36 with the annular surfaces 48, 50, 52 is shown more specifically in FIG. 3.

The first annular surface 48, which is arranged between the second annular surface 50 and the third annular surface 52 in a radial direction and adjoins both surfaces, extends orthogonally to the longitudinal axis 14. The flat armature surface 42 is aligned parallel to the first annular surface 48. In the open position, the armature surface 42 rests on the first annular surface 48.

The second annular surface 50, which is arranged between the first annular surface 48 and the valve needle 26 in a radial direction, slopes in a direction toward the first end 16 relative to an imaginary first extension 54 of the first annular surface 48. The imaginary first extension 54 extends the first annular surface 48 radially inward, i.e. toward the longitudinal axis 14. In other words, the distance between the imaginary first extension 54 and the second annular surface 50 increases radially inward toward the longitudinal axis 14, wherein the second annular surface 50 is arranged on that side of the imaginary first extension 54 which faces away from the armature surface 42. In this case, an angle α which has a value of 2° is formed between the imaginary first extension 54 and the second annular surface 50.

The third annular surface 52 adjoins the first annular surface 48 on the opposite side from the second annular surface 50. It extends radially outward from the first annular surface 48 in a direction toward an outer circumferential surface 58 of the pole element 36. The third annular surface 52 slopes relative to an imaginary second extension 56 of the first annular surface 48 in the direction of the first end 16. The imaginary second extension 56 extends the first annular surface 48 radially outward, i.e. away from the longitudinal axis 14. In other words, the distance between the imaginary second extension 56 and the third annular surface 52 increases radially outward away from the longitudinal axis 14, wherein the third annular surface 52 is arranged on that side of the imaginary second extension 56 which faces away from the armature surface 42.

A chamfer 62 is advantageously formed between the armature surface 42 and a second circumferential surface 60 of the armature 34.

To reduce wear, the armature surface 42 and the pole surface 44 are each coated with a chromium nitride layer 64 and 65, respectively, wherein the chromium nitride layers 64, 65 are applied with the aid of a physical gas phase deposition method to the main bodies of the armature 34 and of the pole element 36, respectively.

It is particularly advantageous if the chromium nitride layer 65 of the pole element 36 is also formed in a through opening of the pole element 36, where the needle sleeve 68 is positioned. The needle sleeve 68 is in sliding contact with a section 72 of the surface of the through opening in order to guide the valve needle 26 axially. The lateral surface 70 of the needle sleeve 68 facing section 72 and the stop surface 71 thereof are also formed by a chromium nitride layer 69 —integral in the present case which is applied circumferentially to a main body of the needle sleeve 68 and to an end of the main body adjacent to the armature 34. In this way, wear is particularly low when the lateral surface 70 moves along the surface of the through opening and when the armature surface 42 strikes the stop surface 71.

1. A fuel injection valve having
a valve body, through which fuel flows and which has a longitudinal axis,
a spray hole,
a valve needle, which is accommodated in an axially movable manner in the valve body and which prevents fuel flow through the spray hole of the fuel injection valve in a closed position and allows fuel flow from the valve body through the spray hole for atomization of the fuel in an open position, and
an electromagnetic actuator which has an armature that is axially movable in the valve body and is mechanically coupled to the valve needle in order to move the valve needle axially, a solenoid for moving the armature, and a pole element that is arranged opposite the armature and is fixed in relation to the valve body, wherein an armature surface of the armature strikes a pole surface of the pole element when the valve needle reaches the open position,
wherein
the valve needle has a needle sleeve which is arranged in an axial through opening of the pole element, with the result that a lateral surface of the needle sleeve is in sliding contact with a section of the surface of the through opening which encircles the longitudinal axis in order to guide the valve needle axially, and
at least one of the section of the surface of the through opening is formed by a chromium nitride layer of the pole element, and the lateral surface of the needle sleeve is formed by a chromium nitride layer of the needle sleeve.

2. The fuel injection valve as claimed in claim 1, wherein—the armature is axially movable in relation to the valve needle,
the armature surface is coupled positively to a stop surface of the needle sleeve in order to move the valve needle axially, and
at least one of the armature surface is formed by a chromium nitride layer of the armature, and the stop surface is formed by a chromium nitride layer of the needle sleeve.

3. The fuel injection valve as claimed in claim 1, wherein at least one of the armature surface is formed by a chromium nitride layer of the armature, and the pole surface is formed by a chromium nitride layer of the pole element.

4. The fuel injection valve as claimed in claim 1, wherein
the pole surface has a first annular surface, which is formed orthogonally to the longitudinal axis and which is aligned parallel to the armature surface and lies opposite the latter,
the armature surface strikes the first annular surface when the valve needle reaches the open position, and
the pole surface and the armature surface are shaped in such a way that a gap is formed between the armature surface and the pole surface radially inward from the first annular surface, the axial extent of said gap increasing radially toward the valve needle.

5. The fuel injection valve as claimed in claim 4, wherein the gap is formed by a second annular surface of the pole surface, which annular surface adjoins the first annular surface in a radially inward direction and at least one of slopes and curves away from the first annular surface in a radial direction toward the longitudinal axis, and away from the armature surface, the armature surface being flat.

6. The fuel injection valve as claimed in claim 4, wherein an angle (α), which has a value of 2°, is formed between the armature surface and the pole surface in the region of the gap.

7. The fuel injection valve as claimed in claim 4, wherein the pole surface has a third annular surface, which, while adjoining the first annular surface, extends radially outward in a direction toward a circumferential surface of the pole element, remote from the longitudinal axis, wherein the third annular surface at least one of slopes and curves in a radial direction away from the longitudinal axis and away from the armature surface, the armature surface being flat.

8. The fuel injection valve as claimed in claim 1, wherein the armature has a chamfer between the armature surface and a circumferential surface, remote from the longitudinal axis, of the armature.

9. The fuel injection valve of claim 1, wherein the chromium nitride layer is formed by a physical gas phase deposition process.

10. A fluid injection valve having a first end for receiving fluid and a second end for exiting the fluid from the fluid injection valve, the fluid injection valve comprising:
a valve body, through which fluid selectively flows and having a longitudinal axis,
a valve needle, which is axially movable within the valve body, the valve needle preventing the fluid from exiting through the second end when the valve needle is in a closed position, and allowing the fluid to exit through the second end when the valve needle is in an open position, and
an electromagnetic actuator comprising an armature axially movable in the valve body and mechanically coupled to the valve needle in order to move the valve needle, a solenoid for moving the armature, and a pole element that is arranged in a fixed position in the valve body, an armature surface of the armature contacts a pole surface of the pole element when the valve needle is in the open position,
wherein the pole element has a through opening and the valve needle has a needle sleeve which is arranged in the through opening of the pole element such that a lateral surface of the needle sleeve is in sliding contact with a surface of the through opening, the through opening encircling the longitudinal axis for axially guiding the valve needle, and
wherein the pole surface comprises a first annular surface, which is formed orthogonally to the longitudinal axis for being contacted by the armature surface when the valve needle is in the open position, and a second annular surface disposed one of radially inwardly and radially outwardly of the first annular surface, the second annular surface being disposed relative to the longitudinal axis such that the second annual surface is not contacted by the armature surface when the needle valve is in the open position, a gap being formed between the armature surface and the second annular surface when the needle valve is in the open position, the gap increasing in a radial direction away from the first annular surface.

11. The fluid injection valve of claim 10, wherein at least one of the through opening and the lateral surface of the needle sleeve comprises a chromium nitride layer.

12. The fluid injection valve of claim 10, wherein at least one of the first annular surface and the armature surface comprises a chromium nitride layer.

13. The fluid injection valve of claim 10, wherein second annular surface is adjacent to a first radial extent of the first annular surface, the pole surface comprises a third annular surface adjacent a second radial extent of the first annular surface such that the first annular surface is disposed between the second and third annular surfaces, the third annular surface being disposed relative to the longitudinal axis such that the third annual surface is not contacted by the armature surface when the needle valve is in the open position, and a second gap is formed between the armature surface and the third annular surface when the needle valve is in the open position, the second gap increasing in a radial direction away from the first annular surface.
